(19) United States
(12) Patent Application Publication
(10) Pub. No.: US 2016/0210633 A1
(43) Pub. Date: Jul. 21, 2016

(54) FRAUD DETECTION SYSTEMS UTILIZING REASONABLE TRAVEL TIME VALUES FROM TRANSACTIONAL DATA

(71) Applicants: Aleksander Epelman, Redwood City, CA (US); Alexei Fomitchev, Hayward, CA (US); Nelli Kayton, San Francisco, CA (US)

(72) Inventors: Aleksander Epelman, Redwood City, CA (US); Alexei Fomitchev, Hayward, CA (US); Nelli Kayton, San Francisco, CA (US)

(21) Appl. No.: 14/996,109

(22) Filed: Jan. 14, 2016

Related U.S. Application Data
(60) Provisional application No. 62/103,953, filed on Jan. 15, 2015.

(51) Int. Cl. G06Q 20/40; G06Q 20/32

(52) U.S. Cl. CPC G06Q 20/4016; G06Q 20/3224

(57) ABSTRACT

Techniques from the proposed invention relate to implementing fraud detection techniques utilizing reasonable travel time values from transactional data. Reasonable travel time (RTT) values can be generated based upon historical transaction data. A time between a pending transaction at a second location and a previous transaction at a first location, for the same account, can be compared to an RTT value associated with the first and second locations. When the time is significantly less than the RTT value, it may be determined that the likelihood of fraud for the pending transaction is substantially higher than if the RTT value is close to the RTT value or significantly exceeds the RTT value.

### CROSS REFERENCE TO RELATED APPLICATIONS

This application is a non-provisional application of and claims the benefit of the filing date of U.S. Provisional Application No. 62/103,953, filed on Jan. 15, 2015, which is herein incorporated by reference in its entirety for all purposes.

### FIELD

Aspects of the disclosure relate to computing technologies and fraud detection systems. In particular, aspects of the disclosure relate to systems, methods, apparatuses, and computer-readable media for implementing fraud detection techniques utilizing reasonable travel time values from transactional data.

### BACKGROUND

Identity theft, unauthorized access, and other types of fraudulent activity are prevalent and cause significant security issues. It can be difficult to distinguish authentic behavior and fraudulent behavior, so fraudulent behavior is often unchecked. Particularly, it is difficult to determine whether the true owner or a fraudster is using a physical token or other credentials to access a system or conduct a transaction.

Embodiments of the invention address these and other problems, individually and collectively. The following detailed description, together with the accompanying drawings will provide a better understanding of the nature and advantages of the present invention.

### BRIEF SUMMARY

Systems, methods, apparatuses, and computer-readable media are described for implementing fraud detection techniques utilizing reasonable travel time values from transactional data. According to some embodiments, fraudulent transaction approvals may be reduced through the utilization of reasonable travel time (RTT) values generated based upon historical transaction data. In some embodiments, a time between a pending/current transaction at a first location and an immediately previous transaction at a second location, for the same account, is compared to an RTT value associated with the first and second locations. If the time is significantly less than the RTT value, it can be determined that the likelihood of fraud for the pending transaction is substantially higher than if the time is close to the RTT value or significantly exceeds the RTT value. Accordingly, in some embodiments, when the time is significantly less than the associated RTT value, a fraud risk score for the transaction may be increased to influence the approval of the transaction request and/or an alert may be generated to notify interested entities (e.g., the true cardholder, an issuer of the account, etc.) as to the detected possibility of fraud. This significance may be determined based upon configurable rules/thresholds.

In some embodiments, a transactional database of historic transaction data from multiple payment accounts may be analyzed to determine highly-accurate RTT values. In some embodiments, sequential in-person transaction pairs from a same account are identified, and the time between the transactions of the pair is determined and associated with the locations of each transaction. In some embodiments, all determined times—across multiple payment accounts—for transaction pairs sharing a common first location and second location may be identified and used to generate an RTT value for those two locations. The locations may be tracked at a variety of levels of granularity, such as at a ZIP code to ZIP code basis, for example. For example, for many pairs of transactions for payment accounts including a first transaction at a first ZIP code and a sequential transaction at a second ZIP code, times for the pairs may be identified and used to generate an RTT value between those two ZIP codes. In some embodiments, an average of each such identified time is determined to serve as the RTT value.

According to some embodiments, a method is described that includes identifying, by a server computer, a plurality of transaction pairs that are associated with a corresponding plurality of user accounts. Each transaction pair includes an initial transaction and a subsequent transaction. Each initial transaction of the plurality of transaction pairs is associated with a first location identifier and each subsequent transaction of the plurality of transaction pairs is associated with a second location identifier. The method also comprises generating, based upon a time difference between each initial transaction and subsequent transaction of the plurality of transaction pairs, a reasonable travel time (RTT) value between the first location and the second location. The method further comprises receiving first transaction data for a first transaction associated with a user account and receiving second transaction data for a second transaction associated with the user account. The first transaction data includes the first location identifier and a first time value and the second transaction data includes the second location identifier and a second time value. The method further comprises determining a time difference between the first time value and the second time value, comparing the time difference to the generated RTT value, and determining, based on comparing the time difference to the generated RTT value, that the time difference meets or exceeds a threshold. The method also comprises generating an alert or modifying a risk score associated with the transaction data.

According to some embodiments, a non-transitory computer-readable storage medium stores instructions which, when executed by a processor of a computing device, cause the computing device to perform this method. According to an embodiment, a computing device is described that includes the processor, one or more network interfaces communicatively coupled to the processor for receiving transaction data, and this non-transitory computer readable storage medium coupled to the processor. In some embodiments, the processor of the computing device may instead be a plurality of processors.

Another embodiment of the invention is directed to a method comprising providing, by a mobile device, user account data for a first transaction. The first transaction takes place at a first location and at a first time. The method further comprises providing the user account data for a second transaction. The second transaction takes place at a second location and at a second time. A server computer determines a time difference between the first time and the second time and compares the time difference to a reasonable travel time (RTT) value between the first location and the second location. The RTT value is generated based on a plurality of transaction pairs that each comprise an initial transaction at an initial time at the first location and a subsequent transaction at a subsequent time at the second location. The server computer determines, based on comparing the time difference to the RTT value, that the time difference meets or exceeds a threshold, and generates an alert or modifies a risk score associated with the transaction data.

Another embodiment of the invention is directed to a mobile device configured to perform the above-described method.

Accordingly, some embodiments can generate fraud risk scores that can work in-concert with other existing fraud risk estimation methods/systems, detect suspicious account uses based upon highly-accurate experience-based RTT statistical measures, and/or notify involved entities to prevent further fraud or even reduce false positive identifications of fraud. An RTT value based on historical data can be more accurate than other methods for determining an RTT value, as other methods might be affected by complexities and irregularities in travel (e.g., schedules, infrastructure, seasons, etc.), while historical data is based on actual travel measurements and averaging the data can correct for random factors. Further, embodiments can perform this RTT value-based analysis rapidly and with small resource requirements, thereby allowing in-band fraud detection (instead of out-of-band, or after-the-fact detection) and reduce the processing/memory/network resource requirements of other fraud detection systems.

### BRIEF DESCRIPTION OF THE DRAWINGS

FIG. 1 illustrates a block diagram of a system according to an embodiment of the invention.

FIG. 2 shows a block diagram of an exemplary user device according to an embodiment of the invention.

FIG. 3 shows a block diagram of an exemplary mobile device according to an embodiment of the invention.

FIG. 4 shows a block diagram of a transaction processing computer according to an embodiment of the invention.

FIG. 5 illustrates exemplary attributes and tuples of a table of an exemplary transaction database according to an embodiment of the invention.

FIG. 6 illustrates a graph depicting one possible conceptual relationship between reasonable travel time (RTT) values and risk scores according to an embodiment of the invention.

FIG. 7 illustrates a flow for generating RTT values based upon multi-user transaction data and using RTT values for transaction fraud detection according to an embodiment of the invention.

### DETAILED DESCRIPTION

Systems, methods, apparatuses, and computer-readable media are described for implementing fraud detection techniques utilizing reasonable travel time values from transactional data. According to some embodiments, fraudulent transaction approvals may be reduced through the utilization of reasonable travel time (RTT) values generated based upon historical transaction data. In some embodiments, a time between a pending/current transaction at a first location and an immediately previous transaction at a second location, for the same account, is compared to an RTT value associated with the first and second locations. If the time is significantly less than the RTT value, it can be determined that the likelihood of fraud for the pending transaction is substantially higher than if the RTT value is close to the RTT value or significantly exceeds the RTT value. Accordingly, in some embodiments, when the time is significantly less than the associated RTT value, a fraud risk score for the transaction may be increased to influence the approval of the transaction request and/or an alert may be generated to notify interested entities (e.g., the true cardholder, an issuer of the account, etc.) as to the detected possibility of fraud.

In some embodiments, a transactional database of historic transaction data from multiple payment accounts may be analyzed to determine highly-accurate RTT values. In some embodiments, sequential in-person transaction pairs from a same account are identified, and the time between the transactions of the pair is determined and associated with the locations of each transaction. In some embodiments, all determined times—across multiple payment accounts—for transaction pairs sharing a common first location and second location may be identified and used to generate an RTT value for those two locations. The locations may be tracked at a variety of levels of granularity, such as at a ZIP code to ZIP code basis, for example. For example, times for many pairs of transactions for payment accounts including a first transaction at a first ZIP code and a sequential transaction at a second ZIP code may be identified and used to generate an RTT value between those two ZIP codes. In some embodiments, an average of each such identified time is determined to serve as the RTT value. In other embodiments, other statistical values can serve as the RTT value, such as a median of each such identified time, a value that is one standard deviation below the average of each such identified time, or any other suitable value that is based on the identified times.

Accordingly, some embodiments can generate fraud risk scores that can work in-concert with other existing fraud risk estimation methods/systems, detect suspicious account uses based upon highly-accurate experience-based RTT statistical measures, and/or notify involved entities to prevent further fraud or even reduce false positive identifications of fraud. Further, embodiments can perform this RTT value-based analysis very rapidly and with small resource requirements, thereby allowing in-band fraud detection (instead of out-of-band, or after-the-fact detection) and reduce the processing/memory/network resource requirements of other fraud detection systems.

Additionally, travel can involve many complexities and irregularities. For example, different regions may have different levels of infrastructure, seasonal and weekly changes can affect travel patterns and schedules, and different people may use different travel means. Accordingly, simple methods for calculating an RTT, such as dividing a distance by a constant speed, can provide an imprecise result. Some embodiments solve these problems by leveraging historical transaction data, which incorporate all of the complexity of travel patterns because these complexities are inherently reflected within the historical authorization data itself. Historical transaction data essential provides directly measured travel times which reflect actual trips affected by the above-described factors.

However, an individual historical travel time may not provide an accurate RTT value, as a single historical example may have involved an indirect route, side-trips during the travel, etc. Embodiments correct for these possible random variations in travel time by leveraging a group of travel times. Averaging (or otherwise statistically manipulating) a set of historical travel times can effectively retrieve information about a typical travel time from otherwise unusable data.

The below description primarily describes payment transactions. However, embodiments can also apply to other types of transactions and fraud-related applications. For example, embodiments can apply to access transactions and access security. An RTT value can similarly be generated based on historical access transactions at different locations, such as providing an access code at a keypad or swiping an access card for entry into a restricted area, or entering a username and password at a computer with an IP address associated with a specific physical location. Then, the a user's travel time between two access transactions can be similarly compared with the RTT value to determine the likelihood that fraud is taking place (e.g., due to a fraudulent access card otherwise compromised access credentials).

Prior to discussing embodiments of the invention, a description of some terms is presented to assist with understanding this disclosure.

A “user account” may include a record associated with an individual or organization at an account provider. Examples of a user account include a payment account, an access account, a secure data account, a membership account, a mobile network account, or any other suitable type of account. A user account may be associated with one or more user devices. In some embodiments, a digital wallet account, which may be associated with multiple user accounts, may be considered a single user account.

A “payment account” may include a user account that is usable for making payments. Examples of a payment account include a credit card account, a bank account such as a checking account or savings account, a prepaid account, or any other suitable account associated with payments. In some embodiments, a payment account may be associated with one or more payment devices. A payment account may be identifiable based on payment account information, such as payment credentials.

“Payment credentials” may include any suitable information associated with an account (e.g., a payment account and/or payment device associated with the account). Such information may be directly related to the account or may be derived from information related to the account. Examples of payment credentials may include a PAN (primary account number or “account number”), user name, expiration date, and verification values such as CVV (card verification value), dCVV (dynamic card verification value), CVV2 (card verification value 2), CVC3 card verification values, etc.

An “access account” may include a type of user account that is usable for obtaining access to a restricted area or restricted information.

A “user device” may include any suitable device that is operated by a user. In some embodiments, a user device may be used to conduct a transaction. For example, a user device may be a “payment device” used to conduct a payment transaction

A “payment device” may include any suitable device that may be used to conduct a financial transaction, such as to provide payment credentials to a merchant. The payment device may be a software object, a hardware object, or a physical object. As examples of physical objects, the payment device may comprise a substrate such as a paper or plastic card, and information that is printed, embossed, encoded, or otherwise included at or near a surface of an object. Suitable payment devices can be hand-held and compact so that they can fit into a user's wallet and/or pocket (e.g., pocket-sized). Example payment devices may include smart cards, magnetic stripe cards, keychain devices (such as the Speedpass commercially available from Exxon-Mobil Corp.), etc. Other examples of payment devices include pagers, payment cards, security cards, access cards, smart media, transponders, and the like. If the payment device is in the form of a debit, credit, or smartcard, the payment device may also optionally have features such as magnetic stripes. Such devices can operate in either a contact or contactless mode.

A “mobile device” may comprise any suitable electronic device that may be transported and operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network. Examples of mobile devices include mobile phones (e.g., cellular phones), PDAs, tablet computers, net books, laptop computers, personal music players, hand-held specialized readers, etc. Further examples of mobile devices include wearable devices, such as smart watches, fitness bands, ankle bracelets, rings, earrings, etc., as well as automobiles with remote communication capabilities.

A “reasonable travel time” or “RTT” may refer and amount of time that may be realistic for a person to travel from one location to another location. For example, an RTT can be a number of seconds, minutes, hours, days, weeks, months, years, and/or any other suitable amount of time. In some embodiments, an RTT can be a typical (e.g., average) amount of time for traveling between two specific locations. In other embodiments, an RTT can be the minimum time needed for the journey. As described in detail below, an RTT can be based on historical data, actual distance, and/or a number of other factors. Various statistical values from historical travel data can be used to determine an RTT. In some embodiments, an RTT can be defined as travel time between various geographic areas. For example, an RTT can represent a travel time between different zip codes, cities, states, countries, store locations, homes, and/or any other suitable type of location.

A “location identifier” may include an indicator associated with a location. A location identifier may be a string of alphanumeric characters or any other suitable value. An example of a location identifier may be a zip code.

A “risk score” may include a value associated with an amount of risk. In some embodiments, a risk score may include an arbitrary designation or ranking that represents the risk that a transaction may be fraudulent. The risk score may be represented by a number (and any scale), a probability, or in any other relevant manner of conveying such information.

An “authorization request message” may be an electronic message that is sent to a transaction processing computer and/or an issuer of a payment card to request authorization for a transaction. An authorization request message according to some embodiments may comply with ISO 8583, which is a standard for systems that exchange electronic transaction information associated with a payment made by a consumer using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), an expiration date, etc.

An “authorization response message” may be an electronic message reply to an authorization request message generated by an issuing financial institution or a transaction processing computer. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the transaction processing computer) to the merchant's access device (e.g., POS equipment) that indicates approval of the transaction. The code may serve as proof of authorization.

A “user” may include an individual. In some embodiments, a user may be associated with one or more user accounts, user devices, and/or mobile devices. The user may also be referred to as a cardholder, account holder, or consumer.

A “resource provider” may be an entity that can provide a resource such as goods, services, information, and/or access. Examples of a resource provider includes merchants, access devices, access points, secure data servers, etc. A “merchant” may typically be an entity that engages in payment transactions and can sell goods or services, or provide access to goods or services.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer”.

An “authorizing entity” may be an entity that authorizes a request. Examples of an authorizing entity may be an issuer, a governmental agency, a document repository, an access administrator, etc. An “issuer” may typically refer to a business entity (e.g., a bank) that maintains an account for a user. An issuer may also issue payment credentials stored on a user device, such as a cellular telephone, smart card, tablet, or laptop to the consumer.

An “access device” may be any suitable device that provides access to a remote system. An access device may also be used for communicating with a merchant computer, a transaction processing computer, an authentication computer, or any other suitable system. An access device may generally be located in any suitable location, such as at the location of a merchant. An access device may be in any suitable form. Some examples of access devices include POS or point of sale devices (e.g., POS terminals), cellular phones, PDAs, personal computers (PCs), tablet PCs, hand-held specialized readers, set-top boxes, electronic cash registers (ECRB), automated teller machines (ATMs), virtual cash registers (VCRs), kiosks, security systems, access systems, and the like. An access device may use any suitable contact or contactless mode of operation to send or receive data from, or associated with, a user mobile device. In some embodiments, where an access device may comprise a POS terminal, any suitable POS terminal may be used and may include a reader, a processor, and a computer-readable medium. A reader may include any suitable contact or contactless mode of operation. For example, exemplary card readers can include radio frequency (RF) antennas, optical scanners, bar code readers, or magnetic stripe readers to interact with a payment device and/or mobile device. In some embodiments, a cellular phone, tablet, or other dedicated wireless device used as a POS terminal may be referred to as a mobile point of sale or an “m POS” terminal.

A “server computer” may be a powerful computer or cluster of two or more computers. For example, the server computer can be a large mainframe, a minicomputer cluster, or a group of servers functioning as a unit. In one example, the server computer may be a database server coupled to a web server. Server computers often execute server applications that act as a server in client-server interactions, including but not limited to database server applications, web server applications, application server applications, etc.

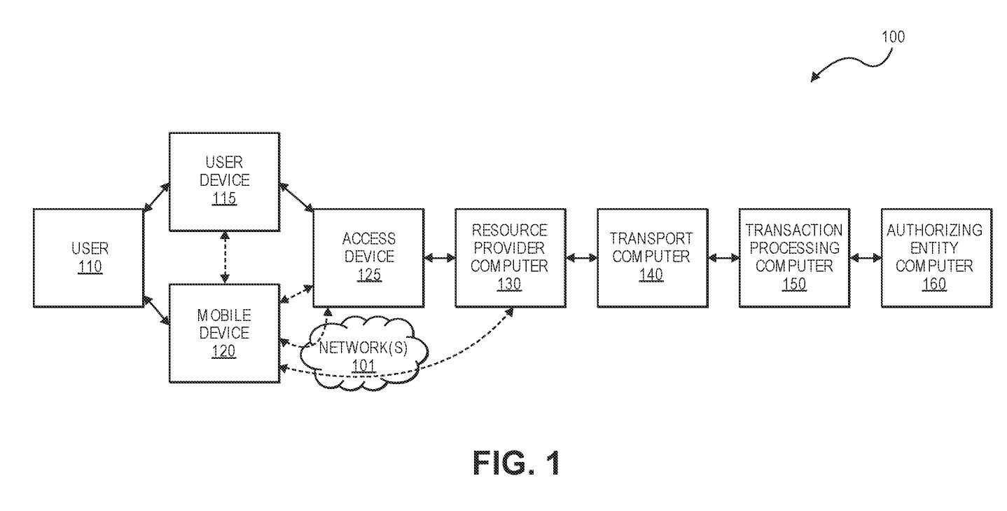

FIG. 1 illustrates a block diagram of a transaction system 100 according to an embodiment of the invention. The system 100 may include a resource provider computer 130 (e.g., a merchant computer) operated by a resource provider (e.g., a merchant), an access device 125, a user device 115 or mobile device 120 associated with a user 110, a transport computer 140 (e.g., an acquirer computer), a transaction processing computer 150 (e.g., a payment processing computer in a payment processing network) operated by a transaction processor (e.g., a payment processor), and an authorizing entity computer 160 (e.g., an issuer computer) operated by an authorizing entity (e.g., an issuer). It is understood that the number of components in FIG. 1 is only for purposes of illustration, and embodiments of the invention can have more or less components than are illustrated in FIG. 1.

In some embodiments, the system 100 may include a merchant having a resource provider computer 130 that comprises an external communication interface (e.g., for communicating with an access device 125 and a transport computer 140), system memory comprising one or modules to generate and utilize electronic messages, and a data processor (for facilitating a financial transaction and the exchange of electronic messages); an acquirer having a transport computer 140 that comprises an external communication interface (e.g., for communicating with a resource provider computer 130 and a transaction processing computer 150), system memory comprising one or modules to generate and utilize electronic messages, and a data processor (for facilitating a financial transaction and the exchange of electronic messages); and an issuer having an authorizing entity computer 160 that comprises an external communication interface (e.g., for communicating with a transaction processing computer 150), system memory comprising one or modules to generate and utilize electronic messages, and a data processor (for facilitating a financial transaction and the exchange of electronic messages). The external communication interface of the resource provider computer 130 may be coupled to an access device 125 (such that information may be received by the access device 125 and communicated to the resource provider computer 130) or, in some embodiments, the access device 125 may comprise a component of the resource provider computer 130.

As used in this context, an “external communication interface” may include any hardware and/or software that enables data to be transferred between two or components of system 100 (e.g., between devices residing at locations such as an issuer, acquirer, merchant, transaction processor, etc.). Some examples of external communication interfaces may include a modem, a network interface (such as an Ethernet card), a communications port, a Personal Computer Memory Card International Association (PCMCIA) slot and card, or the like. Data transferred via external communications interface may be in the form of signals which may be electrical, electromagnetic, optical, or any other signal capable of being received by the external communications interface (collectively referred to as “electronic signals” or “electronic messages”). These electronic messages that may comprise data or instructions may be provided between one or more of the external communications interface via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable method.

As would be understood by one of ordinary skill in the art, any suitable communications protocol for storing, representing, and transmitting data between components in the system 100 may be used. Some examples of such methods may include utilizing predefined and static fields (such as in core TCP/IP protocols); “Field: Value” (or “attribute-value”) pairs (e.g., HTTP, FTP, SMTP, POP3, and SIP); an XML based format; and/or Tag-Length-Value (TLV) format.

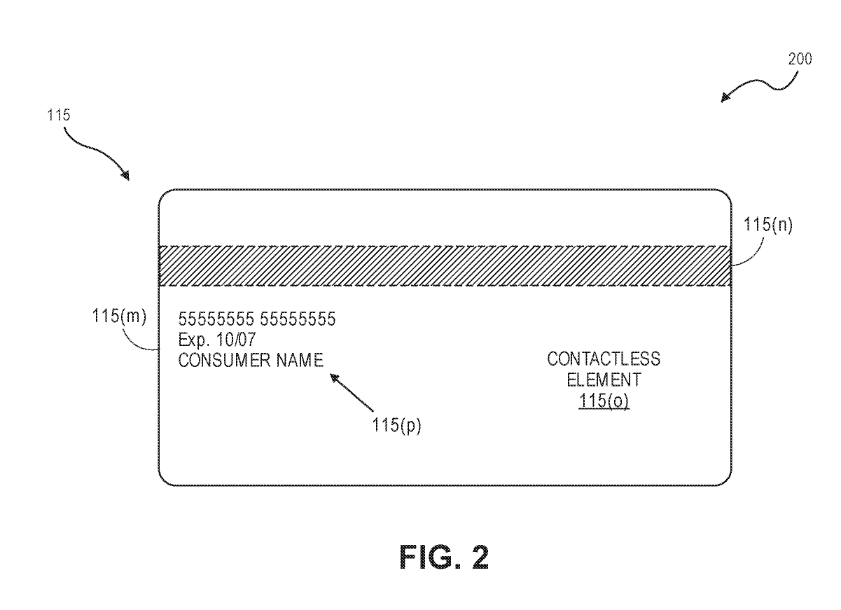

FIG. 2 shows an example of a payment device 115 in the form of a card. As shown, the payment device 115 comprises a plastic substrate 115(m). In some embodiments, a contactless element 115(o) for interfacing with an access device may be present on, or embedded within, the plastic substrate 115(m). A magnetic stripe 115(n) may also or alternatively be on the plastic substrate 115(m). User information 115(p) such as an account number, expiration date, and/or a user name may be printed or embossed on the card. In some embodiments, the payment device 115 may comprise a microprocessor and/or memory chips with user data stored in them.

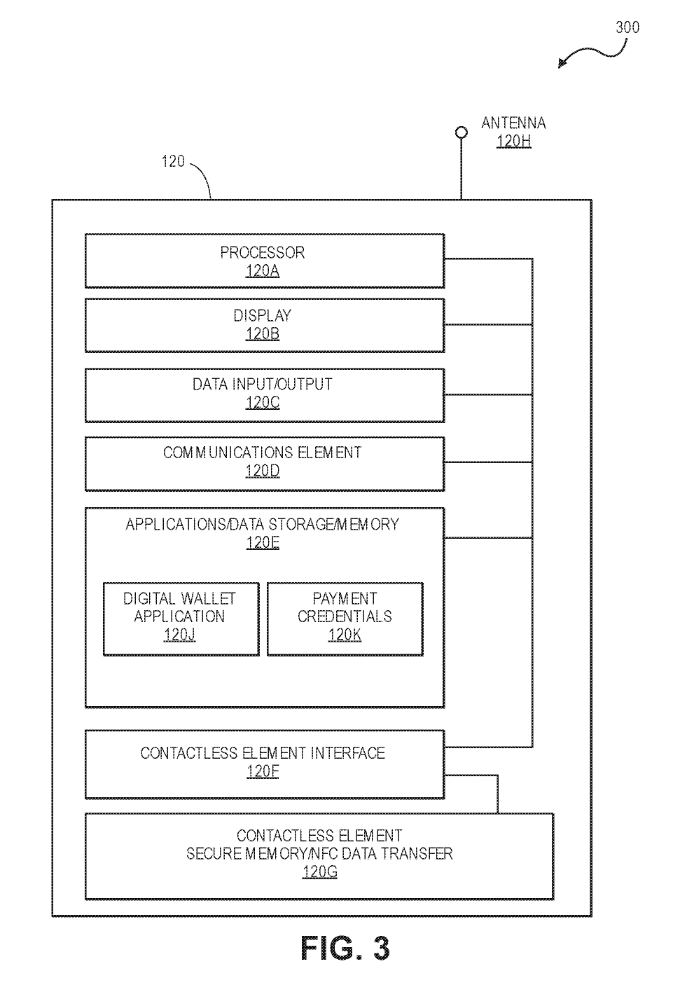

As mentioned above, the user 110 may be also able to conduct a transaction (e.g., provide payment credentials) via the mobile device 120. An example of the mobile device 120, according to some embodiments of the invention, is shown in FIG. 3. Mobile device 120 may include circuitry that is used to enable certain device functions, such as telephony. The functional elements responsible for enabling those functions may include a processor 120A that can execute instructions that implement the functions and operations of the device. Processor 120A may access memory 120E (or another suitable data storage region or element) to retrieve instructions or data used in executing the instructions, such as provisioning scripts and mobile applications. Data input/output elements 120C, such as a keyboard or touchscreen, may be used to enable a user to operate the mobile device 120 and input data (e.g., user authentication data). Data input/output elements may also be configured to output data (via a speaker, for example). Display 120B may also be used to output data to a user. Communications element 120D may be used to enable data transfer between mobile device 120 and a wired or wireless network (via antenna 120H, for example) to assist in connectivity to the Internet or other network, and enabling data transfer functions. Mobile device 120 may also include contactless element interface 120F to enable data transfer between contactless element 120G and other elements of the device, where contactless element 120G may include a secure memory and a near field communications data transfer element (or another form of short range communications technology). As noted, a cellular phone or similar device is an example of a mobile device 120 that may be used in accordance with embodiments of the present invention. However, other forms or types of devices may be used without departing from the underlying concepts of the invention. For example, the mobile device 120 may alternatively be in the form of a payment card, a key fob, a tablet computer, a wearable device, a vehicle such as a car, etc.

The memory 120E may comprise a digital wallet application 120J, payment credentials 120K, and any other suitable module or data. The mobile device 120 may have any number of mobile applications installed or stored on the memory 120E and is not limited to that shown in FIG. 2. The memory 120E may also comprise code, executable by the processor 120A for implementing a method comprising providing user account data for a first transaction, wherein the first transaction takes place at a first location and at a first time; providing user account data for a second transaction, wherein the second transaction takes place at a second location and at a second time, wherein a server computer determines a time difference between the first time and the second time, wherein the server computer compares the time difference to a reasonable travel time (RTT) value between the first location and the second location, the RTT value generated based on a plurality of transaction pairs that each comprise an initial transaction at an initial time at the first location and a subsequent transaction at a subsequent time at the second location, wherein the server computer determines, based on comparing the time difference to the RTT value, that the time difference meets or exceeds a threshold, and wherein the server computer generates an alert or modifies a risk score associated with the transaction data.

The digital wallet application 120J may provide a user interface for the user 110 to provide input and initiate, facilitate, and manage transactions using the mobile device 120. The digital wallet application 120J may be able to store and/or access payment credentials 120K. The digital wallet application 120J may be able to cause the mobile device 120 to transmit the payment credentials 120K in any suitable manner (e.g., NFC, QR code, etc.).

Referring back to FIG. 1, the resource provider computer 130 may submit authorization requests to the transport computer 140. The transport computer 140 may be associated with the resource provider computer 130, and may manage authorization requests on behalf of the resource provider computer 130.

As shown in FIG. 1, the transaction processing computer 150 may be disposed between (in an operational sense) the transport computer 140 and the authorizing entity computer 160. The transaction processing computer 150 may include data processing subsystems, networks, and operations used to support and deliver authorization services, exception file services, and clearing and settlement services. For example, the transaction processing computer 150 may comprise a server coupled to a network interface (e.g., by an external communication interface), and databases of information. The transaction processing computer 150 may be representative of a transaction processing network. An exemplary transaction processing network may include VisaNet. Transaction processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The transaction processing computer 150 may include one or more server computers, and may utilize any suitable wired or wireless network (e.g., network(s) 40), including the Internet, to communicate with other entities.

Although many of the data processing functions and features of some embodiments may be present in the transaction processing computer 150, it should be understood that such functions and features could be present in other components such as the authorizing entity computer 160, and need not be present in the transaction processing computer 150.

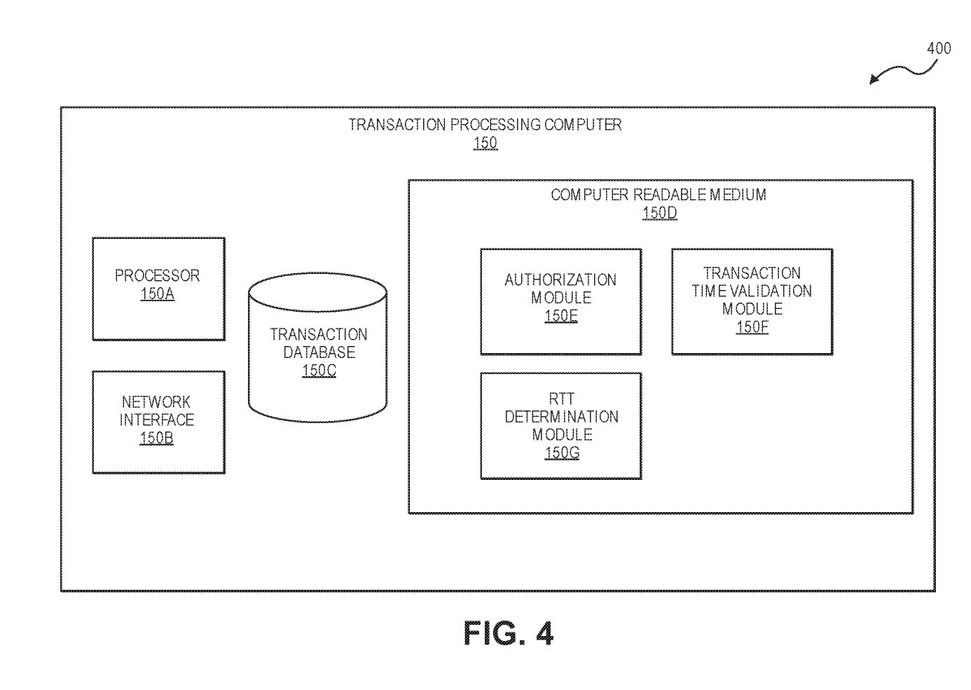

An example of the transaction processing computer 150, according to some embodiments of the invention, is shown in FIG. 4. The transaction processing computer 150 comprises a processor 150A, a network interface 150B, a transaction database 150C, and a computer readable medium 150D.

The computer readable medium 150D may comprise an authorization module 150E, a transaction time validation module 150F, an RTT determination module 150G, and any other suitable software module. The computer readable medium 150D may also comprise code, executable by the processor 150A for implementing a method comprising identifying a plurality of transaction pairs that are associated with a corresponding plurality of user accounts, wherein each transaction pair includes an initial transaction and a subsequent transaction, wherein each initial transaction of the plurality of transaction pairs is associated with a first location identifier and each subsequent transaction of the plurality of transaction pairs is associated with a second location identifier; generating based upon a time difference between each initial transaction and subsequent transaction of the plurality of transaction pairs, a reasonable travel time (RTT) value between the first location and the second location; receiving first transaction data for a first transaction associated with a user account, wherein the first transaction data includes the first location identifier and a first time value; receiving second transaction data for a second transaction associated with the user account, wherein the second transaction data includes the second location identifier and a second time value; determining a time difference between the first time value and the second time value; comparing the time difference to the generated RTT value; determining, by the server computer, based on comparing the time difference to the generated RTT value, that the time difference meets or exceeds a threshold; and generating an alert or modifying a risk score associated with the transaction data.

The RTT determination module 150G may comprise code executable by the processor 150A to determine highly-accurate reasonable travel time (RTT) values indicating a “real” time that may be needed for a person to travel from one location to another location. In some embodiments, these RTT values may be utilized by a transaction time validation module 150F, in conjunction with the processor 150A, for the purpose of determining whether it is likely or unlikely that a person could have made two sequential transactions at different locations based upon the times and locations of the transactions.

For the purpose of this disclosure, RTT values are discussed with respect to travel from one ZIP code to another ZIP code. However, this discussion is made with this context (i.e., ZIP-to-ZIP RTT values) for ease of understanding; other embodiments generate RTT values with respect to different levels of geographic granularity. For example, some embodiments generate RTT values on a merchant-to-merchant basis, shopping center-to-shopping center basis, city-to-city basis, state-to-state basis, region-to-region basis, country-to-country basis, and/or even customized zone-to-customized zone basis (e.g., breaking down geographic areas into customized portions). Further, some embodiments generate RTT values with dissimilar region granularities—e.g., building ZIP-to-city RTT values, ZIP-to-state RTT values, country-to-ZIP values, etc. In some embodiments, it may be useful and convenient to use ZIP-to-ZIP RTT values, as authorization request messages may already include ZIP code information, and therefore each stored transaction may already include ZIP code information. This may also be true for other types of location information (e.g., address, shopping center, city, country, etc.).

Other methods for determining reasonable travel times may be inaccurate, as travel can involve many complexities and irregularities. Many factors can impact how fast people travel from one place to another. For example, some ZIP code regions are “neighboring” or very close such that people can walk between them, while other ZIP code regions can be far away from each other, thus requiring, for example, automobile or air transportation. However, airline schedules frequently change, and there can be seasonal, weekly, and even daily variations in travel patterns. Further, there are densely-populated ZIP codes and sparsely populated ZIP codes. Additionally, there are travel hubs with established travel patterns, and there are remote areas. As a result, it can be extremely complicated to attempt to take into account all of these parameters to construct a model that calculates a “reasonable” travel time from one area to another.

However, some embodiments solve these problems by leveraging historical transaction data (e.g., previous payment authorization transaction details), which incorporate all of the complexity of travel patterns because these complexities are inherently reflected within the historical authorization data itself.

Thus, in some embodiments, the RTT determination module 150G is programmed to calculate reasonable travel time (RTT) values between locations based upon historic transactional data. This calculation may occur to determine (or update) one or more RTT values periodically (e.g., once, once a month, once a day, once an hour), incrementally (e.g., an RTT value may be updated “on-the-fly” as new transaction data flows in), or on-demand (e.g., as an RTT value is needed for fraud/risk determination purposes).

In some embodiments, the RTT determination module 150G can, in conjunction with the processor 150A, process historical transaction authorization data to identify consecutive face-to-face transactions of particular accounts (e.g., cards). In some embodiments, this processing includes identifying sequential “card-present” transactions occurring within a particular threshold amount of time of each other. For example, if two consecutive transactions for a count differ by a period of 5 days, it may be unlikely that the cardholder is doing nothing but travelling for all 5 of those days. Thus, the threshold may be configured according to the desires of the implementing party, and may be set at 8 hours, 12 hours, 24 hours, 36 hours, etc.

In some embodiments, certain card-present transactions may be excluded from the potential pool of sequential card-present transactions. For example, in certain industries face-to-face transactions may not contain real location information associated with the transaction. For example, card-present transactions for in-flight purchases on airlines may not include a “true” location of exactly where the transaction occurred. Similarly, taxi and other transit purchases may not include accurate location data, and transactions from such transaction types/industries may be excluded from the analysis, in some embodiments.

Accordingly, a transaction database 150C of historic transactions (for one or more user accounts associated with one or more users) may be queried to identify transaction pairs—possibly excluding certain types of transactions from consideration, as described above—where each transaction pair has a first transaction of the pair occurring in a first location and has the second transaction of the pair occurring in a second location.

For example, the RTT determination module 150G may, in conjunction with the processor 150A, query the transaction database 150C to identify account transaction pairs where a first transaction occurs in a ZIP code of “90210” and a subsequent transaction of the account occurs in a ZIP code of “10111.” In some embodiments, a strict ordering may be required such that a transaction with a first ZIP code is previous in time to a transaction with a second ZIP code, though in other embodiments, the ordering may be “loose” such that a first transaction pair may include a first transaction with a “90210” ZIP and a second transaction with a “10111” ZIP, and a second transaction pair for the same query can be found/utilized with a first transaction with a “10111” ZIP and a subsequent second transaction in the pair with a “90210” ZIP.

Having identified all matching transaction pairs existing for a period of time (e.g., one or both of the transactions occurred within the last week, within the last month, within the last 6 months, within the last year, happened at any time, etc.) that are specific to two different locations (e.g., ZIPs, or other levels of geographic granularity as needed), the time between each of the transactions (or a “travel time”) for each pair is determined, and these multiple travel times may be used to determine the RTT value. For example, in some embodiments a statistical measure of an average of all determined travel times is determined. In some embodiments, the RTT value is this average, though in some embodiments the RTT value may be based upon this average (e.g., include other factors, such as a multiplier or other modifier(s), or the RTT value may be set as one or more standard deviations from the average). In other embodiments, another statistical measure may be used, including setting the RTT value to the minimum, maximum, mode, median, etc., of the set of travel times. In yet other embodiments, some or all of the travel times may be “thrown out” from consideration to remove some outliers. For example, in some embodiments, the RTT value is set by removing one or more of the smallest and/or largest travel times, and then calculating an average of the remaining travel times.

In some embodiments, the RTT value may be determined with one query or multiple queries, and those of skill in the art understand that these disclosed operations may be consolidated into different numbers and types of queries. Thus, the operations disclosed herein are not intended to imply that only one query or multiple queries are necessitated, but that the different implementations may be crafted based upon the needs of the operating environment, with respect to performance issues, code readability/maintenance issues, etc. For example, certain of the operations above may be consolidated into one query.

Thus, the RTT determination module 150G, in conjunction with the processor 150A, may generate RTT values for different geographic locations and possibly for different geographic granularities and/or types, and may store these RTT values in an RTT database. In some embodiments, the RTT determination module 150G, in conjunction with the processor 150A, generates RTT values for ZIP code transaction pairs, and these RTT values may be generated for all possible combinations of ZIP codes, or only based upon what existing account transaction pairs are found. For example, there may not be any sequential transactional data for any account between two particular ZIP codes; thus, in some embodiments an RTT value may be preset at a configured amount (e.g., set at a configured maximum value such as 10 hours), estimated based upon geographic distances between the ZIP codes, or left as “unknown.”

Additionally, RTT values may be generated “generically” (using transaction pairs from any dates/times) or specific to particular dates, times, or other specific time periods. For example, an RTT value for a pair of locations may be generated using only transaction pairs from weekdays, and a second RTT value for the same pair of locations may be generated using only transaction pairs from holidays. Similarly, an RTT value may also be generated using only transaction pairs from a certain range of hours (e.g., 4 pm-10 pm, to reflect commute traffic), to provide more granularity in the RTT value estimation at a particular time and/or date. Thus, different RTT values for a pair of locations may be utilized to reflect different RTT values during different time periods.

These generated RTT values, which may be stored in an RTT database, can be used in some embodiments by a transaction time validation module 150F (in conjunction with the processor 150A), which may be a submodule of the authorization module 150E, for detecting potential fraudulent transactions.

The authorization module 150E may be programmed to perform some or all the functionality associated with authorizing a financial transaction associated with an authorization request message. The authorization request message may be generated by a resource provider computer 130 and may be associated with a transaction involving the payment device 115 or mobile device 120. The authorization request message may include any suitable information that may be used to authorize or identify the transaction, and may be generated by the resource provider computer 130 in response to an interaction between a payment device 115 or a mobile device 120 and an access device 125. The authorization module 150E may, for instance, be programmed to compare the information received via the authorization request message with stored information (e.g., stored verification values and/or payment account information). In some embodiments, if the received and stored values match, the authorization module 150E, in conjunction with the processor 150A, may authorize the transaction (or may be more likely to authorize the transaction) and generate an authorization response message. The authorization module 150E may also be programmed to execute any further operations associated with authorizations.

As described above, in some embodiments the transaction time validation module 150F may, in conjunction with the processor 150A, perform a timing analysis for a pending transaction (upon the authorization module 150E receiving an authorization request message for a transaction, for example). Thus, in some embodiments the transaction time validation module 150F may, in conjunction with the processor 150A, receive payment credentials such as an account identifier for the pending transaction (e.g., a Primary Account Number (PAN)), a location identifier associated with the pending transaction (e.g., a ZIP code associated with the location of the transaction, such as a merchant ZIP code where a cardholder “swiped” their card at a POS device or provided their payment credentials), and/or a time associated with the transaction (e.g., a time of a swipe/credential presentation, a time that a merchant sent a payment authorization request message, or even a current time observed by the transaction time validation module 150F as it begins, in conjunction with the processor 150A, analysis for that transaction).

Using the account identifier, the transaction time validation module 150F, in conjunction with the processor 150A, may query the transaction database 150C to identify a “last” (e.g., immediately previous) transaction for that account. In some embodiments, this querying may eliminate from consideration certain transactions, such as “card not present” transactions and/or certain “card-present” transactions—as described above with respect to taxi transactions, for example. In some embodiments, if the determined last transaction is “older” than a certain threshold (e.g., 12 hours, 24 hours, 36 hours, etc.), though, the transaction time validation module 150F may be programmed to halt processing and indicate that a time validation cannot occur.

With a determined “last” transaction for the account, the transaction time validation module 150F may be programmed to determine a “current” time difference between the pending transaction and the time of the last transaction. This determination may or may not include normalizing of time data (e.g., accommodating for time zone differences, etc.).

The transaction time validation module 150F may also be programmed to identify the location of the last transaction (e.g., a ZIP code) and the location of the pending location, and use these to identify the RTT value between those locations. In some embodiments, this may include querying an RTT database (or looking up in another type of cache) for a pre-computed RTT value for that pair of geographic indicators, or even querying the RTT determination module 150G for this data, which might even be computed in real time (i.e., “on-demand”).

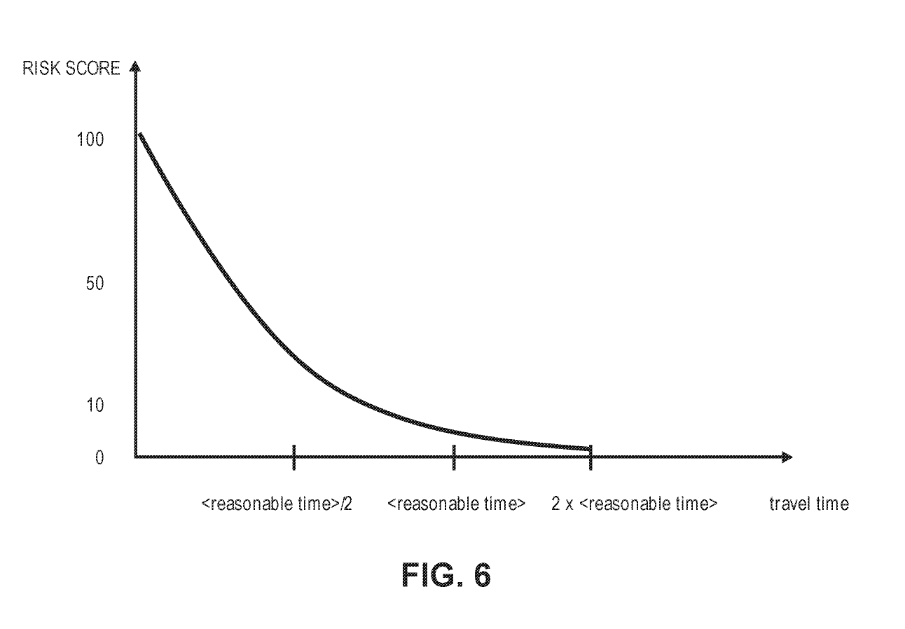

Upon receipt/identification of the RTT value associated with the current transaction location and the last transaction location associated with the account, the transaction time validation module 150F may, in conjunction with the processor 150A, compare the determined “current” time difference (or “travel time”) to the RTT value to determine a likelihood of whether the transaction is fraudulent. In some embodiments, if the current time difference is less than the RTT value, a risk score (e.g., being generated by the authorization module 150E, in conjunction with the processor 150A) may be modified to increase the risk that the transaction is fraudulent. Of course, other configurations may be utilized, and an example of one configuration is described later herein with respect to FIG. 6.

In some embodiments, if the current time difference compared to the RTT value satisfies a particular configured threshold (system-wide threshold, issuer-specific threshold, cardholder-specific threshold, etc.), the transaction time validation module 150F may, in conjunction with the processor 150A, cause an alert to be generated, which may include transmitting a message to an administrator and/or computer of the transaction processing computer 150, authorizing entity computer 160, user 110 (e.g., the mobile device 120), etc. This alert message may be a SMS message or other type of instant message, an electronic mail, etc. In some embodiments, the alert message may include information identifying the account, information identifying the two locations and transaction times, information about how the time difference exceeded an RTT value threshold, or any other suitable information.

In some embodiments, the “last” transaction may be referred to as a first transaction, and the current transaction may be referred to as a second transaction. Thus, when the second transaction is taking place, information associated with the first transaction and an RTT value can be used to determine or adjust a risk score associated with the second transaction.

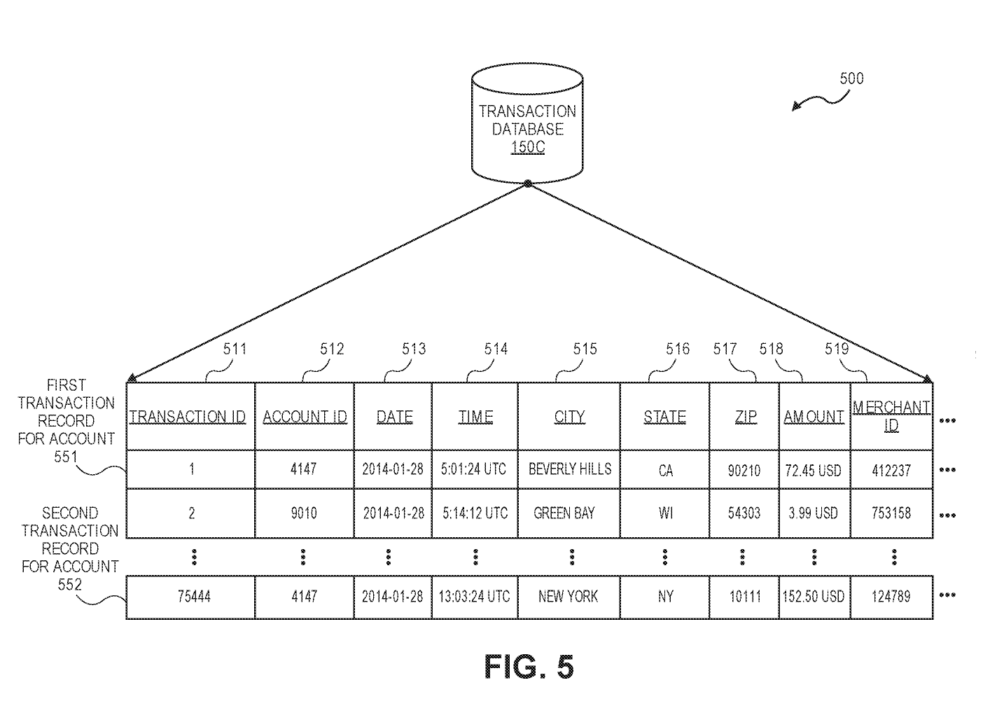

An exemplary transaction database 150C according to an embodiment of the invention with exemplary attributes and tuples of a table is illustrated in FIG. 5. This table includes a plurality of attributes (or columns/fields) 511-519, and a plurality of records (or tuples/rows).

As discussed above, the transaction time validation module 150F, in conjunction with the processor 150A, may query a transaction database 150C to determine a “last” (or “first”) transaction for a particular account involved with a current (or “second”) transaction, and/or the RTT determination module 150G may, in conjunction with the processor 150A, query the transaction database 150C to determine RTT values.

The depicted transaction database 150C is shown as including a transaction table with nine attributes/fields: a transaction identifier 511, an account identifier 512 (e.g., PAN), a date 513 of the transaction, a time 514 of the transaction, a city 515 of the transaction, a state 516 of the transaction, a ZIP code 517 of the transaction, an amount 518 of the transaction (in some currency), and a merchant identifier 519 of the merchant involved in the transaction. Of course, these illustrated fields are merely exemplary and depicted for the purpose of ease of understanding; those of skill in the art would certainly recognize that other and/or different fields may be utilized in a different table or combination of tables.

In this depiction, a first transaction record 550 for an account (e.g., account “4147”) is included as showing a transaction occurring in the ZIP code 517 of “90210” at the time 514 of “5:01:24 UTC” on Jan. 28, 2014. Similarly, a second transaction record 552 for the same account is included and occurs on the same date but at time 514 of “13:03:24 UTC” and in a different ZIP code 517 of “10111.”

In an embodiment, the determination of an RTT value for the ZIP code pair (90210, 10111) may utilize these two records, assuming that they satisfy the “transaction pair” criteria specified by the particular configuration (e.g., travel time is less than a threshold, both transactions are of a particular type, etc.). Thus, a travel time for the pair of 13:03:24 UTC-5:01:24 UTC=8:02:00 (i.e., 8 hours and 2 minutes). This travel time, along with other travel times from other transaction pairs involving these geographic locations (likely involving other accounts), may be used to construct an RTT value for (90210, 10111). For example, an RTT value may be determined to be, for example, 8 hours and 30 minutes between these ZIPs, which may accurately reflect the typical travel time involved with travelling from a Beverly Hills merchant to a nearby airport, making the flight to the New York area, and traveling to a merchant in the 10111 ZIP code area.

FIG. 6 illustrates a graph depicting one possible conceptual relationship between reasonable travel time (RTT) values and risk scores according to an embodiment of the invention. In some embodiments, the transaction time validation module 150F, in conjunction with the processor 150A, determines a current time difference and compares it to an RTT value. As a result, based upon this comparison, the transaction time validation module 150F, in conjunction with the processor 150A, may cause a risk score being generated for a transaction to be modified.

The graph in FIG. 6 illustrates one such modification scheme. The x-axis reflects the current time difference (or “travel time”) between the pending transaction and the last eligible transaction for that account, and the y-axis represents a particular risk score component to be used when determining a risk value for the transaction.

In this depicted embodiment, the transaction time validation module 150F may, in conjunction with the processor 150A, generally cause the risk score to be larger when the current travel time is less than the RTT value than when the current travel time is greater than the RTT value. For example, if the current travel time is much less than the RTT value, it is unlikely that the user actually conducted both transactions, and thus a fraudster may have conducted one or both of the purchases. Conversely, if the current travel time is greater than the RTT value, then this may not imply fraud. In this depiction in FIG. 6, when the current travel time is approximately one-half the RTT value, then the risk score will be set at approximately 20 or 25; when the current travel time is approximately twice the RTT value, the risk score will be set at approximately 0.

In some embodiments, this risk score may be used with a variety of other risk scores for ultimately generating a risk analysis for the transaction. Thus, this risk score may be included independently (i.e., as a broken out, independent value) within a reported risk analysis, or may be consolidated with other risk scores attempting to identify risk based upon other factors (e.g., reported as part of a generic, “overall” risk score).

Thus, the “significance” of the difference between the current travel time and the RTT value may be configured in a customized manner according to the needs of the implementing party (e.g., by changing this graph), to thus reflect what the party determines is likely fraudulent. Further, this graph may be modified over time as additional fraudulent and/or non-fraudulent transactions occur, to thus refine the system according to actual system-observed data. Thus, what difference in time is deemed “significant” may be configured and/or continually modified to achieve the best results.

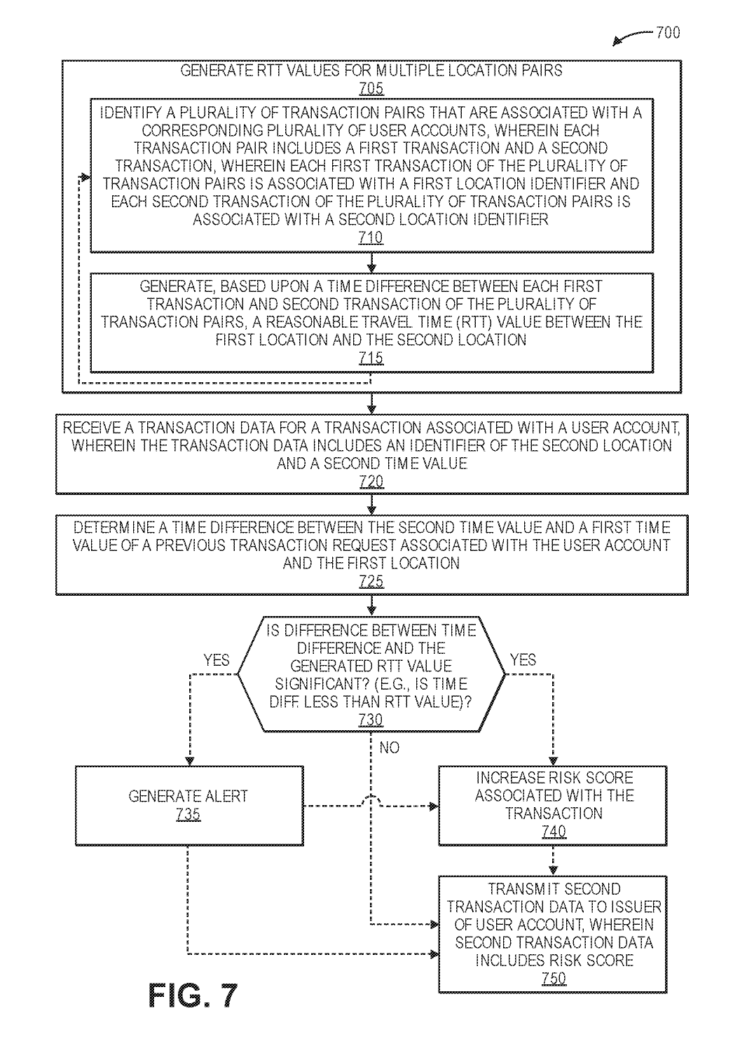

FIG. 7 illustrates a flow for generating RTT values based upon multi-user transaction data and using RTT values for transaction fraud detection according to an embodiment of the invention.

In FIG. 7, block 705 may be performed by the RTT determination module 150G, in conjunction with the processor 150A, and blocks 720-750 may be performed by the transaction time validation module 150F, in conjunction with the processor 150A, for a particular transaction. Of course, these modules may be part of a transaction processing computer 150, and may be implemented within one or multiple computer devices.

The flow 700, at block 705, includes generating RTT values for multiple location pairs. This block 705 may occur “offline” and in advance of any of blocks 725-750. In an embodiment, block 705 includes block 710, in which a plurality of transaction pairs are identified that are associated with a corresponding plurality of user accounts. Each transaction pair includes a first (or “initial”) transaction and a second (or “subsequent”) transaction, and each first transaction is associated with a first location identifier (e.g., a first ZIP code) and each second transaction is associated with a second location identifier (e.g., a second ZIP code).

In an embodiment, block 705 further includes block 715, in which based upon a time difference between each first transaction and second transaction of the plurality of transaction pairs, a reasonable travel time (RTT) value between the first location and the second location is generated. The RTT value for the particular location pair may be a statistical measure (e.g., average) based upon the corresponding time differences of the transaction pairs with those locations.

In some embodiments, block 705 further includes (not illustrated) storing the generated RTT values in an RTT database, which may include storing an identifier of the first location, an identifier of the second location, and the determined RTT value in a table. In some embodiments, though, a lookup mechanism (e.g., using hash values, indexes, etc.) may be implemented whereby one or more of the identifiers of the locations need not be stored.

At block 720, transaction data for a transaction associated with a user account may be received. The transaction may be considered a second transaction, and a previous transaction request associated with the user account may be considered a first transaction. The first transaction is associated with a first location and a first time value, and the received transaction data for the second transaction includes an identifier of the second location and a second time value. At block 725, the flow 700 includes determining a time difference between the first time value and the second time value.

The flow 700 continues with decision block 730, where the time difference is compared to the generated RTT value between the first location and the second location, and where it is determined whether the time difference is less than the generated RTT value (or whether the time difference otherwise meets or exceeds a threshold). If not, the flow 700 may terminate, or optionally continue with transmitting a second transaction data (e.g., possibly modified authentication request) to an issuer of the identified account, which may or may not include a risk score generated by the transaction processing computer.

Decision block 730, as illustrated, details one particular way to determine whether the difference between the time difference and the generated RTT value for the particular locations is deemed “significant.” Although decision block 730 deems it significant (i.e., an increased likelihood of fraud exists) when the time difference is simply less than the corresponding RTT value, other embodiments may be configured to determine this significance in different ways. For example, in some embodiments “significance” may occur when the time difference is less than the RTT value as well as when it only exceeds the RTT value by a particular amount (e.g., 5%, 10%, 25%, etc.). Additionally, in some embodiments, “significance” is determined when the time difference is less than the RTT value by a particular amount (e.g., a percentage, or number of minutes, etc.). For example, it may be deemed significant only when the time difference is at least 15% less than the RTT value and not when the time difference is only 0-14% less than the RTT value. Accordingly, in different embodiments the significance can be flexibly configured differently based upon later-determined false positives and/or false negatives observed by the system.

If the time difference is indeed less than the generated RTT value between the first location and the second location, the flow 700 may continue with generating an alert 735, which may be sent to a device or account of a cardholder/user, the transaction processing computer or the associated issuer, etc. From there, the flow 700 may optionally continue with either of blocks 740 and 750, to be discussed next.

Instead of (or in addition to) generating an alert at block 735, the flow 700 may continue with block 740, in which a risk score associated with the transaction is increased (or otherwise computed). This may occur similar to the discussion with respect to FIG. 6, though in other embodiments other modifications to the risk score may occur, which are often configured to cause the transaction to be viewed as “riskier” when the current time difference is less than the RTT value. Then, at block 750, the risk score may be sent/transmitted within a second transaction data (e.g., by modifying and forwarding the authorization request message) to an issuer of the user account, to provide the issuer with the detailed analysis of the risk of the transaction from the perspective of the transaction processing computer. In some embodiments, the issuer may then determine whether or not to authorize the transaction at least in part based on the risk score associated with the transaction.

Embodiments of the invention have a number of advantages. For example, embodiments of the invention can generate fraud risk scores that can work in-concert with other existing fraud risk estimation methods/systems, detect suspicious account uses based upon highly-accurate experience-based RTT statistical measures, and/or notify involved entities to prevent further fraud or even reduce false positive identifications of fraud. An RTT value based on historical data can be more accurate than other methods for determining an RTT value, as other methods might be affected by complexities and irregularities in travel (e.g., schedules, infrastructure, seasons, etc.), while historical data is based on actual travel measurements that inherently account for such complexities because travel actually took place. While a single historical travel time may be affected by random user behaviors, embodiments also correct for these random factors by averaging (or otherwise combining) a set of historical travel times. Further, embodiments can perform this RTT value-based analysis rapidly and with small resource requirements, thereby allowing in-band fraud detection (instead of out-of-band, or after-the-fact detection) and reduce the processing/memory/network resource requirements of other fraud detection systems.

A computer system will now be described that may be used to implement any of the entities or components described herein. Subsystems in the computer system are interconnected via a system bus. Additional subsystems include a printer, a keyboard, a fixed disk, and a monitor which can be coupled to a display adapter. Peripherals and input/output (I/O) devices, which can couple to an I/O controller, can be connected to the computer system by any number of means known in the art, such as a serial port. For example, a serial port or external interface can be used to connect the computer apparatus to a wide area network such as the Internet, a mouse input device, or a scanner. The interconnection via system bus allows the central processor to communicate with each subsystem and to control the execution of instructions from system memory or the fixed disk, as well as the exchange of information between subsystems. The system memory and/or the fixed disk may embody a computer-readable medium.

As described, the inventive service may involve implementing one or more functions, processes, operations or method steps. In some embodiments, the functions, processes, operations or method steps may be implemented as a result of the execution of a set of instructions or software code by a suitably-programmed computing device, microprocessor, data processor, or the like. The set of instructions or software code may be stored in a memory or other form of data storage element which is accessed by the computing device, microprocessor, etc. In other embodiments, the functions, processes, operations or method steps may be implemented by firmware or a dedicated processor, integrated circuit, etc.

Any of the software components or functions described in this application may be implemented as software code to be executed by a processor using any suitable computer language such as, for example, Java, C++, Python, or Perl using, for example, conventional, functional, and/or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

Although many embodiments were described above as comprising different features and/or combination of features, a person of ordinary skill in the art after reading this disclosure may understand that in some instances, one or more of these components could be combined with any of the components or features described above. That is, one or more features from any embodiment can be combined with one or more features of any other embodiment without departing from the scope of the invention.

The use of “a”, “an” or “the” is intended to mean “at least one”, unless specifically indicated to the contrary. Reference to a “first” component does not necessarily require that a second component be provided. Moreover reference to a “first” or a “second” component does not limit the referenced component to a particular location unless expressly stated.

What is claimed is:

1. A method, comprising:
identifying, by a server computer, a plurality of transaction pairs that are associated with a corresponding plurality of user accounts, wherein each transaction pair includes an initial transaction and a subsequent transaction, wherein each initial transaction of the plurality of transaction pairs is associated with a first location identifier and each subsequent transaction of the plurality of transaction pairs is associated with a second location identifier;
generating, by the server computer, based upon a time difference between each initial transaction and subsequent transaction of the plurality of transaction pairs, a reasonable travel time (RTT) value between the first location and the second location;
receiving, by the server computer, first transaction data for a first transaction associated with a user account, wherein the first transaction data includes the first location identifier and a first time value;
receiving, by the server computer, second transaction data for a second transaction associated with the user account, wherein the second transaction data includes the second location identifier and a second time value;
determining, by the server computer, a time difference between the first time value and the second time value;
comparing, by the server computer, the time difference to the generated RTT value;
determining, by the server computer, based on comparing the time difference to the generated RTT value, that the time difference meets or exceeds a threshold; and
generating, by the server computer, an alert or modifying a risk score associated with the transaction data.

2. The method of claim 1, wherein the time difference meets or exceeds a threshold when the time difference is less than the generated RTT value.

3. The method of claim 1, further comprising:
transmitting, by the server computer, to an authorizing entity computer associated with the user account, the second transaction data including the risk score.

4. The method of claim 1, further comprising:
transmitting, by the server computer, to a mobile device associated with the user account, the alert.

5. The method of claim 1, wherein modifying a risk score associated with the transaction data includes increasing the risk score.

6. A transaction processing computer comprising:
a processor; and
a computer readable medium, the computer readable medium comprising code, executable by the processor, for implementing a method comprising:
identifying a plurality of transaction pairs that are associated with a corresponding plurality of user accounts, wherein each transaction pair includes an initial transaction and a subsequent transaction, wherein each initial transaction of the plurality of transaction pairs is associated with a first location identifier and each subsequent transaction of the plurality of transaction pairs is associated with a second location identifier;
generating based upon a time difference between each initial transaction and subsequent transaction of the plurality of transaction pairs, a reasonable travel time (RTT) value between the first location and the second location;
receiving first transaction data for a first transaction associated with a user account, wherein the first transaction data includes the first location identifier and a first time value;
receiving second transaction data for a second transaction associated with the user account, wherein the second transaction data includes the second location identifier and a second time value;
determining a time difference between the first time value and the second time value;
comparing the time difference to the generated RTT value;
determining, by the server computer, based on comparing the time difference to the generated RTT value, that the time difference meets or exceeds a threshold; and
generating an alert or modifying a risk score associated with the transaction data.

7. The first computer of claim 6, wherein the first location identifier is a first zip code and the first location is a first region associated with the first zip code, and wherein the second location identifier is a second zip code and the second location is a second region associated with the second zip code.

8. The first computer of claim 6, wherein the first location identifier is associated with a first resource provider identifier and the first location is a first resource provider location associated with the first resource provider identifier, and wherein the second location identifier is associated with a second resource provider identifier and the second location is a second resource provider location associated with the second resource provider identifier.

9. The first computer of claim 6, wherein the first transaction data is received via a first authorization request message, and wherein the second transaction data is received via a second authorization request message.

10. The first computer of claim 6, further comprising:
after receiving the second transaction data for the second transaction associated with the user account, retrieving the first transaction data for the first transaction associated with the user account, wherein the first transaction data is identified based on the user account.

11. A method comprising:
providing, by a mobile device, user account data for a first transaction, wherein the first transaction takes place at a first location and at a first time; and
providing, by the mobile device, the user account data for a second transaction, wherein the second transaction takes place at a second location and at a second time,
wherein a server computer determines a time difference between the first time and the second time,
wherein the server computer compares the time difference to a reasonable travel time (RTT) value between the first location and the second location, the RTT value generated based on a plurality of transaction pairs that each comprise an initial transaction at an initial time at the first location and a subsequent transaction at a subsequent time at the second location,
wherein the server computer determines, based on comparing the time difference to the RTT value, that the time difference meets or exceeds a threshold, and
wherein the server computer generates an alert or modifies a risk score associated with the transaction data.

12. The method of claim 11, wherein a time difference between the initial time and the subsequent time is determined for each of the plurality of transaction pairs, and wherein the RTT value is generated by averaging the time differences.

13. The method of claim 12, wherein outliers from the time differences are not used for generating the RTT value.

14. The method of claim 11, wherein each transaction in the plurality of transaction pairs is a face-to-face transaction.

15. The method of claim 11, wherein the RTT value is further based on a second plurality of transaction pairs that each comprise an initial transaction at an initial time at the second location and a subsequent transaction at a subsequent time at the first location.

16. A mobile device comprising:
a processor; and
a computer readable medium, the computer readable medium comprising code, executable by the processor, for implementing a method comprising:
providing user account data for a first transaction, wherein the first transaction takes place at a first location and at a first time; and
providing user account data for a second transaction, wherein the second transaction takes place at a second location and at a second time,
wherein a server computer determines a time difference between the first time and the second time,
wherein the server computer compares the time difference to a reasonable travel time (RTT) value between the first location and the second location, the RTT value generated based on a plurality of transaction pairs that each comprise an initial transaction at an initial time at the first location and a subsequent transaction at a subsequent time at the second location,
wherein the server computer determines, based on comparing the time difference to the RTT value, that the time difference meets or exceeds a threshold, and
wherein the server computer generates an alert or modifies a risk score associated with the transaction data.

17. The mobile device of claim 16, wherein the RTT value includes a first RTT value and a second RTT value, wherein the first RTT value is associated with a first time period and the second RTT value is associated with a second time period.

18. The mobile device of claim 16, wherein the mobile device does not conduct any transactions between the first transaction and the second transaction.

19. The mobile device of claim 16, wherein the server computer is a transaction processing computer.

20. The mobile device of claim 16, wherein the server computer is an authorizing entity computer.
